(19) United States
(12) Patent Application Publication
(10) Pub. No.: US 2009/0035491 A1
(43) Pub. Date: Feb. 5, 2009

(54) Ink-Jet Recording Material

(76) Inventors: Koichi Takei, Tokyo (JP); Hiroshi Sakaguchi, Toyko (JP); Norimasa Miyachi, Toyko (JP)

Correspondence Address: BIRCH STEWART KOLASCH & BIRCH, PO BOX 747, FALLS CHURCH, VA, 22040-0747, US

(21) Appl. No.: 11/886,912

(22) PCT Filed: Mar. 31, 2006
(86) PCT No.: PCT/JP2006/306794

§ 371 Date: Sep. 21, 2007

(30) Foreign Application Priority Data
Mar. 31, 2005 (JP) 2005-101085
Aug. 8, 2005 (JP) 2005-229929

(51) Int. Cl. B41M 5/50

(52) U.S. Cl. 428/32.37

(57) ABSTRACT

In the present invention, there is provided an ink-jet recording material which comprises, on a support, at least one ink-receptive layer containing fine inorganic particles having an average secondary particle size of 500 nm or less, a resin binder having an acetoacetyl group, and a compound having two or more terminal hydrazino groups, wherein the at least one ink-receptive layer contains at least one organic acid having a pKa of 2 to 5.

### TECHNICAL FIELD

The present invention relates to an ink-jet recording material, more specifically to an ink-jet recording material which is advantageous not only in that it has photo-like high glossiness and exhibits excellent ink-absorption ability, but also in that it suffers no surface cracking or no discoloration in the printed portion and has high productivity.

### BACKGROUND ART

As a recording material to be used for an ink-jet recording system, a recording material which comprises an ink-receptive layer being provided on a support such as paper or plastic resin film, etc. has been known. The ink-receptive layer can be roughly classified into two types. One of which is an ink-receptive layer mainly comprising a water-soluble polymer, and the other is an ink-receptive layer mainly comprising an inorganic pigment and a resin binder.

In the former type of the ink-receptive layer, ink is absorbed by the water-soluble polymer that is swelling. In the latter type of the ink-receptive layer, ink is absorbed in voids formed by the inorganic pigments. Due to such a difference in mechanism of absorbing ink, the former type is called to as a swelling type (or a polymer type) and the latter is called to as a void type.

In the former type of the ink-receptive layer, glossiness is excellent since it forms a continuous uniform film but ink-absorption ability (an ink-absorption rate; a drying rate after printing) is poor. On the other hand, in the latter void type, ink-absorption ability is excellent but glossiness is poor.

In recent years, a recording material excellent in both of the ink-absorption ability and glossiness has been earnestly desired, and a void type recording material using ultrafine inorganic particles as a pigment has been proposed. For example, it has been proposed to use ultrafine inorganic particles such as a fumed silica (a gas phase process silica) or a wet process silica, etc., pulverized and dispersed to have an average secondary particle size of 500 nm or less as a pigment component for an ink-receptive layer. For example, in Japanese Patent Publication No. Hei.3-56552, Japanese Laid-Open Patent Publications No. Hei.10-119423, No.2000-211235 and No.2000-309157, there have been disclosed to use fumed silica, in Japanese Laid-Open Patent Publications No. Hei.9-286165 and No. Hei.10-181190, there have been disclosed to use pulverized silica prepared by a precipitation process, and in Japanese Laid-Open Patent Publication No.2001-277712, there has been disclosed to use pulverized silica prepared by a gel process. Moreover, in Japanese Laid-Open Patent Publications No. Sho.62-174183, No. Hei.2-276670, No. Hei.5-32037 and No. Hei.6-199034, there have been disclosed recording materials using an alumina or an alumina hydrate.

However, when ultrafine inorganic particles as mentioned above are used, high glossiness can be obtained but to the contrary, the coating solution is likely to increase in viscosity, and is applied at a low solids content, and hence surface defects such as a dryer air pattern or cracks, etc. likely caused at the time of drying. In particular, polyolefin resin-coated paper (those in which a polyolefin resin such as polyethylene, etc. is laminated on both surfaces of paper) or a non-water-absorptive support such as polyester film, etc., is used to obtain high glossiness or good feelings, the support cannot absorb ink, so that an ink absorption ability of the ink-receptive layer provided on a support is important. Accordingly, to heighten void ratio and void volume of an ink-receptive layer, the ink-receptive layer is required to be constituted by a large amount of a pigment and a low ratio of a binder, and as a result, at the time of coating and drying the ink-receptive layer, dryer air patterns and cracks are easily generated more and more.

To prevent such surface defects, it has been known a method in which a coating solution containing a cross-linking agent is coated on a support, and then, drying process is carried out under relatively mild conditions. For example, in Japanese Laid-Open Patent Publications No. Hei.10-119423, No. 2000-27093, No. 2001-96900, etc., there are disclosed a method in which a boron compound such as boric acid, borate, borax, etc., is used as a cross-linking agent of polyvinyl alcohol, a coating solution is coated and then once cooled to increase a viscosity of the coated solution, and drying process is carried out at a relatively low temperature. Also, it has been known, as a cross-linking agent, an aldehyde type compound, an epoxy compound, or an isocyanate, etc. However, it is difficult to achieve both excellent cross-linking and excellent properties of the ink-jet recording material, and defects are often caused in the coating film due to the conditions for application and drying, and a slight change of the drying temperature may cause marked application failures. Further, there is a disadvantage in that the coating film is so rigid that so-called cracks by folding are caused in the coating film when the recording material is folded. Furthermore, particularly the drying step requires a long period of time, leading to a problem in that the productivity cannot be improved.

Further, as a technique for preventing the surface defects including cracks, the use of a resin binder having an acetoacetyl group has been known. Such a technique is described in, for example, Japanese Laid-Open Patent Publication Nos. 2003-335043 (Patent Literature 1), 2004-230609 (Patent Literature 2), 2004-268576 (Patent Literature 3), and 2004-268577 (Patent Literature 4).

However, it is newly found that the ink-jet recording material using such a binder suffers discoloration in the portion printed with ink-jet ink after a certain amount of time has lapsed.

### [Patent Literature 1] Japanese Laid-Open Patent Publication No. 2003-335043

### [Patent Literature 2] Japanese Laid-Open Patent Publication No. 2004-230609

### [Patent Literature 3] Japanese Laid-Open Patent Publication No. 2004-268576

### [Patent Literature 4] Japanese Laid-Open Patent Publication No. 2004-268577

### DISCLOSURE OF THE INVENTION

### Problems to be solved by the invention

The object of the present invention is to provide an ink-jet recording material which is advantageous not only in that it has photo-like high glossiness and exhibits excellent ink-absorption ability and excellent color reproduction as well as high productivity, but also in that it suffers no discoloration in the printed portion.

### Means to solve the problems

The above-mentioned object of the present invention can be accomplished by the following inventions.
(1) An ink-jet recording material comprising, on a support, at least one ink-receptive layer containing fine inorganic particles having an average secondary particle size of 500 nm or less, a resin binder having an acetoacetyl group, and a compound having two or more terminal hydrazino groups, wherein the at least one ink-receptive layer contains at least one organic acid having a pKa of 2 to 5.
(2) The ink-jet recording material according to item (1) above, wherein an amount of the organic acid having a pKa of 2 to 5 is 0.01 to 1 g per 1 m² of the ink-jet recording material.
(3) The ink-jet recording material according to item (1) above, wherein the fine inorganic particles comprise amorphous synthetic silica.
(4) The ink-jet recording material according to item (1) above, wherein the ink-receptive layer containing the organic acid having a pKa of 2 to 5 further contains at least one alkali metal salt of an organic acid in an amount such that an alkali metal ion amount is 10 to 120 mol %, based on per mol of the organic acid having a pKa of 2 to 5.
(5) The ink-jet recording material according to item (4) above, wherein an amount of the organic acid having a pKa of 2 to 5 is 0.01 to 3.0 g per 1 m² of the ink-jet recording material.
(6) The ink-jet recording material according to item (4) above, wherein the fine inorganic particles comprise alumina or alumina hydrate.

### EFFECTS OF THE INVENTION

By practicing the present invention, there can be obtained an ink-jet recording material which is advantageous not only in that it has photo-like high glossiness and exhibits excellent ink-absorption ability and excellent color reproduction as well as high productivity, but also in that it suffers no discoloration in the printed portion while being stored.

### BEST MODE FOR CARRYING OUT THE INVENTION

Hereinbelow, the present invention will be described in detail. An ink-jet recording material which comprises, on a support, at least one ink-receptive layer containing fine inorganic particles, a resin binder having an acetoacetyl group, and a compound having two or more terminal hydrazino groups has a problem in that, when the recording material printed with ink-jet ink is stored for a long term, the recording material suffers discoloration in the printed portion. Extensive and intensive studies have been made with a view toward solving the above problem. As a result, it has been found that, when at least one ink-receptive layer in the ink-jet recording material contains at least one organic acid having a pKa of 2 to 5, the ink-jet recording material can be prevented from suffering discoloration in the printed portion, and the present invention has been completed.

Further, it has been found that, when the ink-receptive layer further contains an alkali metal salt of an organic acid in an amount such that an alkali metal ion amount is 10 to 120 mol %, based on per mol of the organic acid contained in at least one ink-receptive layer in the ink-jet recording material, the discoloration can be more effectively prevented and the production efficiency can be further improved.

Discoloration of the printed portion which is the problem to be solved by the present invention is a phenomenon such that the printed portion or the periphery of the printed portion is discolored red. This phenomenon is a problem characteristic of the ink-jet recording material using a resin binder having an acetoacetyl group with a compound having two or more terminal hydrazino groups in combination.

The above discoloration is particularly affected by an amount of the compound having two or more terminal hydrazino groups contained in the recording material. The compound having two or more terminal hydrazino groups contained in too large an amount causes marked discoloration, and the compound contained in a small amount may be acceptable.

When the compound having two or more terminal hydrazino groups is contained in too small an amount, a cross-linking reaction of the resin binder having an acetoacetyl group does not proceed satisfactorily, so that the resultant recording material has poor ink-absorption ability, or cracks are caused in the recording material or the coated surface is uneven due to air in a dryer during the coating and drying for the recording material.

When the organic acid or the organic acid and the alkali metal salt in the present invention are present during the coating and drying for the ink-jet recording material, a cross-linking reaction of the compound having two or more terminal hydrazino groups and the resin binder having an acetoacetyl group is promoted. This indicates that the ink-jet recording material can be produced using a smaller amount of the compound having two or more terminal hydrazino groups, thus preventing the occurrence of discoloration.

As the fine inorganic particles having an average secondary particle size of 500 nm or less to be used in the ink-receptive layer of the present invention, there may be mentioned conventionally known various kinds of fine particles such as amorphous synthetic silica, alumina, alumina hydrate, calcium carbonate, magnesium carbonate, titanium dioxide, etc., and amorphous synthetic silica, alumina or alumina hydrate is preferred in the points of ink-absorption ability and productivity.

The amorphous synthetic silica can be roughly classified into wet process silica, fumed silica, and others. The wet process silica can be further classified into a precipitation method silica, a gel method silica, and a sol method silica according to the preparation processes. The precipitation method silica can be prepared by reacting sodium silicate and sulfuric acid under alkali conditions, silica particles grown in particle size aggregated and precipitated, and then, they are processed through filtration, washing, drying, pulverization and classification to prepare a product. As the precipitation method silica, it is commercially available, for example, as Nipsil from TOSOH SILICA CORPORATION, and as Tokusil from K.K. Tokuyama. The gel method silica can be produced by reacting sodium silicate and sulfuric acid under acidic conditions. In this method, small particles are dissolved during maturing and reprecipitated occurs in which primary particles are combined to each other. Thus, definite primary particles disappear and relatively hard agglomerated particles having internal void structure are formed. It is commercially available, for example, as Nipgel from TOSOH SILICA CORPORATION, and as Syloid or Sylojet from Grace Japan Co., Ltd. The sol method silica is also called to as colloidal silica and can be obtained by heating and maturing silica sol obtained by metathesis of sodium silicate by using an acid, etc., or passing through an ion-exchange resin layer, and is commercially available, for example, as SNOWTEX from Nissan Chemical Industries, Ltd.

The fumed silica is also called to as the dry process silica contrary with the wet process silica, and it can be generally prepared by a flame hydrolysis method. More specifically, it has generally been known a method in which silicon tetrachloride is burned with hydrogen and oxygen, and silanes such as methyltrichlorosilane, trichlorosilane, etc., may be used in place of silicon tetrachloride, singly or in admixture with the silicon tetrachloride. The fumed silica is commercially available as Aerosil from Nippon Aerosil K.K., and as QS type from K.K. Tokuyama.

In the present invention, fumed silica is particularly preferably used. An average primary particle size of the fumed silica to be used in the present invention is preferably 30 nm or less, and more preferably 15 nm or less to obtain higher glossiness. More preferred are to use those having an average primary particle size of 3 to 15 nm (particularly 3 to 10 nm), and having a specific surface area measured by the BET method of 200 m²/g or more (preferably 250 to 500 m²/g). Incidentally, the average primary particle size referred to in the present invention means an average particle size of fine particles using 100 primary particles existing in a predetermined surface area and diameters of the circles thereof equivalent to the projected surface area of the respective primary particles according to electron microscopic observation as a particle diameter of fine particles, and the BET method mentioned in the present invention means one of methods for measuring a surface area of powder material by a gas phase adsorption method and is a method for obtaining a total surface area possessed by 1 g of a sample, i.e., a specific surface area, from an adsorption isotherm. In general, as an adsorption gas, nitrogen gas has frequently been used, and a method of measuring an adsorption amount obtained by the change in pressure or a volume of a gas to be adsorbed has most frequently been used. The most famous equation for representing isotherm of polymolecular adsorption is the Brunauer-Emmett-Teller equation which is also called to as the BET equation and has widely been used for determining a surface area of a substance to be examined. A surface area can be obtained by measuring an adsorption amount based on the BET equation and multiplying an amount with a surface area occupied by the surface of one adsorbed molecule.

In the ink-receptive layer of the present invention, a fumed silica is preferably used by dispersing the fumed silica to have an average secondary particle size of 500 nm or less, preferably 30 to 300 nm, further preferably 30 to 200 nm in the presence of a cationic compound. As a dispersing method, the fumed silica and a dispersing medium are provisionally mixed with general propeller stirring, turbine type stirring, homomixer type stirring, etc., then, dispersing treatment is preferably carried out by using a media mill such as a ball mill, a beads mill, a sand grinder, etc., a pressure type dispersing machine such as a high pressure homogenizer, a ultra-high pressure homogenizer, etc., a ultrasonic wave dispersing machine, and a thin film spin system disperser, etc. Incidentally, an average secondary particle size referred to in the present invention means an average value of the dispersed aggregated particles which can be observed by the ink-receptive layer of the resulting recording material using an electron microscope.

In the present invention, a wet process silica in which it is pulverized to have an average secondary particle size of 500 nm or less may be preferably used. As the wet process silica particles to be used in the present invention, the wet process silica particles having an average primary particle size of 50 nm or less, preferably 3 to 40 nm, and an average agglomerated particle size of 5 to 50 μm are preferred, and it is preferred to use the above wet process silica fine particles by finely pulverizing them by an average secondary particle size of 500 nm or less, preferably 30 to 400 nm, further preferably 30 to 300 nm or so in the presence of a cationic compound.

The wet process silica prepared by the general method has an average aggregated particle size of 1 μm or more, so that it is used by subjecting to fine pulverization. As the pulverization method, a wet dispersing method in which silica dispersed in an aqueous medium is mechanically pulverized can be preferably used. At this time, increase in initial viscosity of the dispersion can be controlled, dispersion with a high concentration can be realized and a pulverization and dispersion efficiency can be realized so that the particles can be pulverized finer, so that precipitation method silica having an oil absorption amount of 210 ml/100 g or less, and an average agglomerated particle size of 5 μm or more is preferably used. By using a dispersion with a high concentration, productivity of the printing paper is improved. The oil absorption amount can be measured based on the description of JIS K-5101.

As a specific method for obtaining wet process silica fine particles having an average secondary particle size of 500 nm or less in the present invention, first, silica particles and the cationic compound may be mixed (in any order or at the same time) in water, or individual dispersions or aqueous solutions thereof may be mixed, and a provisional dispersion is obtained using at least one of a saw blade type dispersing device, a propeller blade type dispersing device, and a rotor stator type dispersing device. If necessary, a suitable amount of a low boiling point solvent, etc., may be further added to the dispersion. A solid concentration of the silica provisional dispersion is preferably as high as possible, but if it is too high concentration, dispersion becomes impossible, so that the solid concentration is preferably in the range of 15 to 40% by weight, more preferably 20 to 35% by weight. Next, a wet process silica fine particle dispersion having an average secondary particle size of 500 nm or less can be obtained by applying thereto to a more potent mechanical means. As the mechanical means, those conventionally known in the art can be employed, and there may be used, for example, a media mill such as a ball mill, a beads mill, a sand grinder, etc., a pressure type dispersing device such as a high-pressure homogenizer, an ultra high-pressure homogenizer, etc., an ultrasonic wave dispersing device, and a thin-film spin type dispersing device, etc.

As the cationic compound to be used for dispersion of the above-mentioned fumed silica and wet process silica, a cationic polymer or a water-soluble metal compound can be used. As the cationic polymer, preferably used are polyethyleneimine, polydiallylamine, polyallylamine, alkylamine polymer, as well as polymers having a primary to tertiary amino group or a quaternary ammonium group as disclosed in Japanese Laid-Open Patent Publication No. Sho.59-20696, No. Sho.59-33176, No. Sho.59-33177, No. Sho.59-155088, No. Sho.60-11389, No. Sho.60-49990, No. Sho.60-83882, No. Sho.60-109894, No. Sho.62-198493, No. Sho.63-49478, No. Sho.63-115780, No. Sho.63-280681, No. Hei.1-40371, No. Hei.6-234268, No. Hei.7-125411, No. Hei.10-193776, etc. In particular, a diallylamine derivative is preferably used as the cationic polymer. A weight average molecular weight (Mw) of these cationic polymers is preferably 2,000 to 100,000 or so, particularly preferably 2,000 to 30,000 or so in view of dispersibility and a viscosity of the dispersion.

As examples of water-soluble metal compounds, there can be mentioned water-soluble polyvalent metal salts, and, of these, preferred is a compound comprising aluminum or a metal belonging to Group 4A of the Periodic Table (e.g., zirconium or titanium). Especially preferred is a water-soluble aluminum compound. As water-soluble aluminum compounds, there are known inorganic salts, such as aluminum chloride or a hydrate thereof, aluminum sulfate or a hydrate thereof, and ammonium alum. Further, a basic polyaluminum hydroxide compound which is an inorganic aluminum-containing cationic polymer is known and preferably used.

The basic polyaluminum hydroxide compound is comprising mainly a component represented by the general formula 1, 2, or 3 below, and is a water-soluble polyaluminum hydroxide stably containing a basic, high molecular-weight polynuclear condensed ion, such as [Al₆(OH)₁₅]³⁺, [Al₈(OH)₂₀]⁴⁺, [Al₁₃(OH)₃₄]⁵⁺, or [Al₂₁(OH)₆₀]³⁺.

[Al₂(OH)ₙCl₆₋ₙ]ₘ General formula 1

[Al(OH)₃]ₙAlCl₃ General formula 2

Alₙ(OH)ₘCl₍₃ₙ₋ₘ₎(0<m<3n) General formula 3

These compounds are commercially available, for example, as polyaluminum chloride (PAC), water treatment agent, from TAKI CHEMICAL CO., LTD., as polyaluminum hydroxide (Paho) from Asada Kagaku Co., Ltd., and as Pyurachemu WT from Rikengreen CO., Ltd., and products for the similar use are commercially available from other manufacturers, and reagents of various grades are easily available.

With respect to the water-soluble compound comprising an element belonging to Group 4A of the Periodic Table used in the present invention, a water-soluble compound comprising titanium or zirconium is more preferred. Examples of water-soluble compounds comprising titanium include titanium chloride and titanium sulfate. Examples of water-soluble compounds comprising zirconium include zirconium chloride, zirconium oxychloride, zirconium hydroxychloride, zirconium nitrate, basic zirconium carbonate, zirconium hydroxide, ammonium zirconium carbonate, potassium zirconium carbonate, zirconium sulfate, and zirconium fluoride compounds. In the present invention, the “water-soluble” means to be dissolved in water in an amount of 1% by weight or more at room temperature under atmospheric pressure.

As the alumina to be used in the present invention, γ-alumina which is a γ type crystal of aluminum oxide is preferred, and of these, δ group crystal is preferred. The γ-alumina can be made fine with a primary particle size of 10 nm or so, and generally those pulverized to have an average secondary particle size of 500 nm or less, preferably 20 to 300 nm or so may be used by pulverizing secondary particle crystals having several thousand to several ten thousand nm with an ultrasonic wave, a high pressure homogenizer or a counter-collision type jet pulverizer, etc.

The alumina hydrate of the present invention can be shown by the structural formula of Al₂O₃·nH₂O (n=1 to 3). When n is 1, it represents alumina hydrate with boehmite structure, and when n is larger than 1 and less than 3, it represents a pseudo boehmite structure alumina hydrate. It can be obtained by a conventionally known method, such as hydrolysis of aluminum alkoxide such as aluminum isopropoxide, etc., neutralization of aluminum salt with an alkali, hydrolysis of aluminate, etc. An average secondary particle size of alumina hydrate to be used in the present invention is 500 nm or less, preferably 20 to 300 nm.

In the ink-receptive layer in the present invention, a ratio of the fine inorganic particles having an average secondary particle size of 500 nm or less to be contained is preferably 50% by weight or more based on the total solid content of the ink-receptive layer, more preferably 60% by weight or more, especially preferably in the range of 65 to 90% by weight.

In the ink-receptive layer in the present invention, a resin binder having an acetoacetyl group is used as a binder resin of the fine inorganic particles. The resin binder having an acetoacetyl group can be synthesized by introducing an acetoacetyl group by the polymerization reaction. For example, an acetoacetyl group can be introduced by the reaction of a hydroxy group and a diketene, etc. Specific examples of the resin binder having an acetoacetyl group may be mentioned, acetoacetyl-modified polyvinyl alcohol, acetoacetyl-modified cellulose derivative, acetoacetyl-modified starch, diacetoneacryl-amide-modified polyvinyl alcohol, etc. In the present invention, modified polyvinyl alcohol having an acetoacetyl group is particularly preferred.

The acetoacetyl-modified polyvinyl alcohol can be prepared by a conventionally known method such as a reaction of polyvinyl alcohol and diketene, etc. An acetoacetylation degree thereof is preferably 0.1 to 20 mol6, more preferably 1 to 15 mol%. A saponification degree thereof is preferably 80 mol % or more, more preferably 85 mol % or more. A polymerization degree thereof is preferably 500 to 5000, particularly preferably 1,000 to 4500.

In the present invention, in addition to the resin binder having an acetoacetyl group, other conventionally known resin binder(s) may be used in combination. For example, cellulose derivative(s) such as carboxymethyl cellulose, hydroxypropyl cellulose, etc.; starch or various kinds of modified starches; gelatin or various kinds of modified gelatins; chitosan, carrageenan, casein, soybean protein, polyvinyl alcohol or various kinds of modified polyvinyl alcohols, polyvinyl pyrrolidone, polyacrylamide, etc. may be used in combination, if necessary. Moreover, various kinds of latexes may be used in combination as a resin binder.

At this time, in the point of glossiness, a resin binder having high compatibility with the resin binder having an acetoacetyl group is preferably used in combination. When the modified polyvinyl alcohol having an acetoacetyl group is used, a completely or partially-saponified polyvinyl alcohol or cationically-modified polyvinyl alcohol is preferably used in combination. In particular, polyvinyl alcohol having a saponification degree of 80% or more and an average polymerization degree of 200 to 5000 is preferably used.

The cationically-modified polyvinyl alcohol is a polyvinyl alcohol having a primary to tertiary amino group or a quaternary ammonium group at the main chain or side chain of the polyvinyl alcohol as disclosed in, for example, Japanese Unexamined Patent Publication No. Sho.61-10483.

With respect to an amount of another resin binder used, there is no particular limitation as long as both the effect of the resin binder having an acetoacetyl group and the effect of the below-mentioned compound having two or more terminal hydrazino groups can be obtained.

The total content of the resin binder is preferably in the range of 5 to 40% by weight based on an amount of the fine inorganic particles, particularly preferably 10 to 30% by weight. The total content of the resin binder in the above range is preferred in the point that a void volume (void) in the ink-receptive layer is large so that an ink-absorption ability becomes high.

The terminal hydrazino group means a hydrazino group having one nitrogen atom unsubstituted and another nitrogen atom bonded to the other structural portion of the molecule. Examples of partial structures containing a terminal hydrazino group in the present invention include partial structures, such as hydrazine, carboxylic acid hydrazide, semicarbazide, carbohydrazide, sulfonic acid hydrazide, and imidic acid hydrazide, and especially preferred is a carboxylic acid hydrazide or semicarbazide structure. The two or more hydrazino groups are bonded through an arbitrary organic group, such as an aliphatic group, an aromatic group, or a heterocyclic group. Specific examples of the compounds having two or more terminal hydrazino groups in the present invention include 4,4′-methylenebis(phenylhydrazine), 2,4,6-trihydrazino-1,3,5-triazine, a polycarboxylic acid hydrazide such as carbohydrazide, thiocarbohydrazide, diaminoguanidine, succinic acid dihydrazide, adipic acid dihydrazide, citric acid trihydrazide, sebacic acid dihydrazide, isophthalic acid dihydrazide, etc., a reaction product of polyiso-cyanate and hydrazine such as 4,4′-ethylenedisemicarbazide, 4,4′-hexamethylenedisemicarbazide, etc., a polymer type hydrazide such as polyacrylic acid hydrazide, etc. In particular, in the points of water-solubility and reactivity, succinic acid dihydrazide, adipic acid dihydrazide is/are preferred.

With respect to an amount of the compound having two or more terminal hydrazino groups contained in the present invention, there is no particular limitation, but, from the viewpoint of achieving excellent productivity and obtaining an ink-receptive layer having excellent properties, the amount of the compound having two or more terminal hydrazino groups is preferably in the range of from 0.1 to 50% by weight, further preferably in the range of from 1 to 20% by weight, based on the weight of the resin binder having an acetoacetyl group.

In the present invention, another known hardener may be further used. When modified polyvinyl alcohol is used as the resin binder, as a cross-linking agent (hardener) for the polyvinyl alcohol, there can be used an aldehyde compound, such as formaldehyde or glutaraldehyde, a ketone compound, such as diacetyl or chloropentanedione, bis(2-chloroethylurea), 2-hydroxy-4,6-dichloro-1,3,5-triazine, a compound having a reactive halogen described in U.S. Pat. No. 3,288,775, divinyl sulfone, a compound having a reactive olefin described in U.S. Pat. No. 3,635,718, an N-methylol compound described in U.S. Pat. No. 2,732,316, an isocyanate described in U.S. Pat. No. 3,103,437, an aziridine compound described in U.S. Pat. Nos. 3,017,280 and 2,983,611, a carbodiimide compound described in U.S. Pat. No. 3,100,704, an epoxy compound described in U.S. Pat. No. 3,091,537, a halogencarboxyaldehyde, such as mucochloric acid, a dioxane derivative, such as dihydroxydioxane, or an inorganic cross-linking agent, such as chromium alum, zirconium sulfate, boric acid, borate, or borax.

In the present invention, the ink-receptive layer contains an organic acid having a pKa of 2 to 5. Specific examples of the organic acids include formic acid (pKa=3.75), acetic acid (pKa=4.76), citric acid (pKa₁=3.13), lactic acid (pKa=3.86), malonic acid (pKa₁=2.85), succinic acid (pKa₁=4.19), malic acid (pKa₁=3.40), tartaric acid (pKa₁=3.04), fumaric acid (pKa₁=3.03), benzoic acid (pKa=4.20), ascorbic acid (pKa=4.10), benzenesulfonic acid (pKa2.55), and 2,4-dinitrophenol (pKa=4.10). With respect to the pKa, for example, values described in “Kagaku Binran, Kiso-hen (Handbook of Chemistry, Basic Edition)”, 2nd revised edition (1975, published by Maruzen Co. Ltd.) can be used. The pKa in the present invention is a value as measured in water at 25° C. In the organic acid which undergoes multistep acid dissociation, the pKa means pKa₁ which is a dissociation constant on the first step. In the present invention, among these organic acids, preferred is an organic monocarboxylic acid, more preferred is an aliphatic monocarboxylic acid, and especially preferred is acetic acid or lactic acid.

In the present invention, it is preferred that the ink-receptive layer further contains an alkali metal salt of an organic acid. Examples of alkali metal salts of an organic acid usable in the present invention include sodium formate, potassium formate, sodium acetate, potassium acetate, sodium lactate, potassium lactate, sodium benzoate, potassium benzoate, sodium ascorbate, sodium benzenesulfonate, and potassium benzenesulfonate. In the present invention, of these alkali metal salts of an organic acid, preferred is an alkali metal salt of an organic carboxylic acid, and more preferred is an alkali metal salt of an aliphatic monocarboxylic acid.

An amount of the alkali metal salt of an organic acid added in the present invention is preferably an amount such that the alkali metal ion amount is 10 to 120 mol %, based on per mol of the organic acid having a pKa of 2 to 5 contained in the ink-receptive layer. When the alkali metal ion amount is less than 10 mol %, it is likely that an effect aimed at by adding the alkali metal salt of an organic acid cannot be obtained. The amount of the alkali metal salt of an organic acid is further preferably an amount such that the alkali metal ion amount is 35 to 100 mol %.

Discoloration which is the problem to be solved by the present invention is a phenomenon such that the printed portion or the periphery of the printed portion is discolored red after the recording material printed by an ink-jet printer has been stored for a long term. This is a phenomenon characteristic of the ink-jet recording material using a resin binder having an acetoacetyl group with a compound having two or more terminal hydrazino groups in combination. Complete elucidation of the mechanism of the occurrence of the discoloration has not yet been made, but one mechanism of the discoloration is presumed that alkaline ink drops are applied to the ink-receptive layer to partially increase the pH of the ink-receptive layer. The organic acid having a pKa of 2 to 5 also has an advantage in that it can be added without sacrificing the coating properties, color reproduction, and glossiness of the ink-jet recording material of the present invention. The reason for this is presumed that the organic acid having the pKa defined in the present invention is added to form a buffer, preventing the pH increase. When an acid having a pKa of less than 2 was used in the preparation of ink-jet recording paper, such an effect was not obtained.

When the alkali metal salt of an organic acid is not added, an amount of the organic acid having a pKa of 2 to 5 is preferably 0.01 to 1 g, especially preferably 0.1 to 0.6 g per 1 m² of the ink-jet recording material. Further, the amount of the organic acid is preferably in the range of from 0.2 to 25% by weight, based on the weight of the resin binder having an acetoacetyl group. When the amount of the organic acid falls within the above range, discoloration of the printed portion with the passage of time is effectively prevented.

When the alkali metal salt of an organic acid is added, the amount of the organic acid having a pKa of 2 to 5 is preferably 0.01 to 3.0 g, especially preferably 0.1 to 2.7 g per 1 m² of the ink-jet recording material. It is presumed that, when the alkali metal salt of an organic acid is added, the ink-receptive layer is prevented from lowering in pH to excess, making it possible to increase the amount of the organic acid having a pKa of 2 to 5.

Instead of the alkali metal salt of an organic acid, a mixture of the organic acid and an alkali may be added. Examples of alkalis usable in the present invention include sodium hydroxide, potassium hydroxide, barium hydroxide, magnesium hydroxide, and calcium hydroxide.

With respect to the coating method for the ink-jet recording material of the present invention, a single coating solution containing the resin binder having an acetoacetyl group and the compound having two or more terminal hydrazino groups may be applied to a support, or separate coating solutions respectively containing the resin binder having an acetoacetyl group and the compound having two or more terminal hydrazino groups may be mixed upon preparing the recording material. The resin binder having an acetoacetyl group is reacted with hydrazide in the coating solution to increase the viscosity of the coating solution, making it difficult to apply the coating solution, and therefore, preferred is a method in which the separate coating solutions are simultaneously applied using the below-mentioned coating device to form layers or a method in which the separate coating solutions are successively applied. In the successive application, it is necessary that a coating solution containing the compound having two or more terminal hydrazino groups be applied after a coating solution containing the fine inorganic particles and the resin binder having an acetoacetyl group is applied and before the coating solution applied is completely dried. When the coating solution containing the fine inorganic particles and the resin binder having an acetoacetyl group is dried in the absence of the compound having two or more terminal hydrazino groups, cracks are disadvantageously caused. Specifically, the successive application may be performed in the following order: a coating solution containing the fine inorganic particles and the resin binder having an acetoacetyl group is applied to the support onto which a coating solution containing the compound having two or more terminal hydrazino groups is preliminarily applied and dried; a coating solution containing the compound having two or more terminal hydrazino groups is applied to a support, and, before the coating solution is dried, a coating solution containing the fine inorganic particles and the resin binder having an acetoacetyl group is applied to the support; or a coating solution containing the fine inorganic particles and the resin binder having an acetoacetyl group is applied to a support, and, before the coating solution is dried, a coating solution containing the compound having two or more terminal hydrazino groups is applied to the support.

With respect to the method of obtaining the ink-receptive layer containing an organic acid having a pKa of 2 to 5, the organic acid may be preliminarily added to a coating solution, and, when separate coating solutions respectively contain the resin binder having an acetoacetyl group and the compound having two or more terminal hydrazino groups as mentioned above, the organic acid may be added to either the coating solution containing the fine inorganic particles and the resin binder having an acetoacetyl group or the coating solution containing the compound having two or more terminal hydrazino groups. Alternatively, a coating solution containing the organic acid may be applied simultaneously with the formation of the ink-receptive layer containing the fine inorganic particles, the resin binder having an acetoacetyl group, and the compound having two or more terminal hydrazino groups by the above-mentioned simultaneous multilayer application method. Further alternatively, before or after the ink-receptive layer is dried, a solution containing the organic acid may be applied to the surface of the ink-receptive layer by, e.g., spraying, or a coating solution containing the fine inorganic particles and the resin binder having an acetoacetyl group and a coating solution containing the compound having two or more terminal hydrazino groups may be applied to the support onto which a coating solution containing the organic acid is preliminarily applied.

With respect to the method of obtaining the ink-receptive layer containing an alkali metal salt of an organic acid in the present invention, the alkali metal salt needs be added to the coating solution having a pH preadjusted to the acid side, and therefore it is preferred that all of or part of the organic acid having a pKa of 2 to 5 is mixed into the coating solution before adding the alkali metal salt. When the alkali metal salt is solely added to the coating solution, the coating solution may disadvantageously suffer aggregation. With respect to the method for adding a mixture of the alkali metal salt of an organic acid and the organic acid having a pKa of 2 to 5, the mixture may be added to either a coating solution containing the fine inorganic particles and the resin binder having an acetoacetyl group or a coating solution containing the compound having two or more terminal hydrazino groups. Alternatively, a coating solution containing the fine inorganic particles and the resin binder having an acetoacetyl group and a coating solution containing the compound having two or more terminal hydrazino groups may be applied to the support onto which a coating solution containing a mixture of the alkali metal salt of an organic acid and the organic acid having a pKa of 2 to 5 is preliminarily applied. The timing of the addition is necessarily to be between the preparation of the coating solution containing the fine inorganic particles and the resin binder having an acetoacetyl group to the completion of drying of the coating solution applied.

A process is preferred in which the coating solution is applied and then allowed to undergo gelation by heating, followed by drying. In the present invention, the gelation means a state in which the coating solution has an increased viscosity such that it does not flow due to the air blown during the drying step, preferably means a state in which the coating solution has substantially no flowability.

As a method for heating the coating solution applied to the support, there can be used a method in which the resultant support is passed through air at a high temperature, a method in which the support is brought into contact with a heated roll, or a method in which an infrared heater or a microwave heater is used. The heating temperature varies depending on the composition of the coating solution, such as the amounts of the resin binder having an acetoacetyl group and the compound having hydrazino groups, but, when the coating solution is of an aqueous system, the heating temperature is preferably in the range of from 30 to 100° C., especially preferably from 40 to 95° C. Generally, a reaction of an acetoacetyl group with hydrazine or a hydrozide group rapidly proceeds, and therefore, from the viewpoint of achieving high productivity, the heating time is preferably 1 second to 10 minutes, further preferably 5 seconds to 5 minutes.

As the dry coated amount of the ink-receptive layer of the present invention, it is generally in the range of 8 to 40 g/m², particularly preferably in the range of 10 to 30 g/m² as a solid content of the fine inorganic particles in view of ink-absorption ability, strength of the ink-receptive layer, and productivity.

In the present invention, for the purpose of improvement in water resistance of ink dye, etc., it is preferred to further add a cationic compound to the ink-receptive layer. Examples of cationic compounds include the cationic polymers and water-soluble metal compounds mentioned at the explanation of dispersion of silica. Examples of water-soluble metal compounds include water-soluble salts of a metal selected from calcium, barium, manganese, copper, cobalt, nickel, iron, zinc, chromium, magnesium, tungsten, and molybdenum. Specific examples include calcium chloride, calcium sulfate, barium sulfate, barium phosphate, manganese chloride, ammonium manganese sulfate hexahydrate, copper(II) chloride, ammonium copper(II) chloride dihydrate, copper sulfate, cobalt chloride, cobalt thiocyanate, cobalt sulfate, nickel sulfate hexahydrate, nickel chloride hexahydrate, ammonium nickel sulfate hexahydrate, nickel amidosulfate tetrahydrate, iron(II) bromide, iron(II) chloride, iron(III) chloride, iron(II) sulfate, iron(III) sulfate, zinc bromide, zinc chloride, zinc nitrate hexahydrate, zinc sulfate, zinc p-phenolsulfonate, chromium sulfate, magnesium sulfate, magnesium chloride hexahydrate, sodium phosphotungstate, 12-tungstophosphoric acid n-hydrate, 12-tungstosilicic acid 26-hydrate, molybdenum chloride, and 12-molybdophosphoric acid n-hydrate. Of these, preferred is a cationic polymer having a weight average molecular weight (Mw) of about 5,000 to 100,000 or a compound comprising aluminum or a metal belonging to Group 4A of the Periodic Table (e.g., zirconium or titanium), and especially preferred is an aluminum compound. The cationic compounds may be used individually or in combination.

In the ink-jet recording material of the present invention, in addition to the at least one ink-receptive layer, as another ink-receptive layer, an ink absorption layer, or a layer having a different function such as a protective layer, etc., may be further provided.

In the present invention, to each ink-receptive layer, various kinds of conventionally known additives such as a surfactant, a coloring dye, a coloring pigment, a fixing agent for an ink coloring agent, a UV ray absorber, an antioxidant, a dispersant of pigment, a defoaming agent, a leveling agent, an antiseptic agent, a fluorescent brightener, a viscosity stabilizer, etc., may be further added.

As the support to be used in the present invention, there may be used a film such as a polyethylene, polypropylene, polyvinyl chloride, diacetate resin, triacetate resin, cellophane, acrylic resin, polyethylene terephthalate, polyethylene naphthalate, etc., a water-resistant support such as a polyolefin resin-coated paper, etc., and a water-absorptive support such as uncoated paper, art paper, coated paper, cast-coated paper, etc. A water-resistant support is preferably used. Among the water-resistant supports, especially preferred is a polyolefin resin-coated paper. A thickness of these supports is preferably that having about 50 to 250 μm or so.

When a non-water-absorptive support, such as a film or a resin-coated paper, is used as a support, a primer layer comprising mainly a natural polymer compound or a synthetic resin is preferably provided on the surface on which the ink-receptive layer is to be provided. The primer layer formed on the support is comprising mainly a natural polymer compound such as gelatin, casein, etc., or a synthetic resin. Examples of the synthetic resins include acrylic resin, polyester resin, vinylidene chloride, vinyl chloride resin, vinyl acetate resin, polystyrene, polyamide resin, polyurethane resin, etc. The primer layer having a thickness (dried thickness) of 0.01 to 5 μm, preferably in the range of 0.01 to 2 μm is formed on the support.

Onto the support of the present invention, various kinds of back coating layer(s) may be provided by coating for the purpose of providing writability, antistatic property, conveying property, anticurl property, etc. In the back coating layer, an inorganic antistatic agent, an organic antistatic agent, a hydrophilic binder, a latex, a pigment, a curing agent, a surfactant, etc. may be included in an optional combination.

When a coating solution of an ink-receptive layer is provided on a film support or a resin-coated paper, it is preferred to carry out a corona discharge treatment, flame treatment, UV ray irradiation treatment, plasma treatment, etc., prior to provision of the coating.

In the present invention, as the coating method for the individual layers constituting the ink-receptive layer, a known coating method can be used. Examples include a slide bead system, a curtain system, an extrusion system, an air knife system, a roll coating system, and a rod bar coating system.

In the following, the present invention is explained in more detail by referring to Examples, but the present invention is not limited by these Examples. Incidentally, all “part(s)” and “%” mean “part(s) by weight” and “% by weight” of a solid component, respectively.

### EXAMPLE 1

### <Preparation of Polyolefin Resin-Coated Paper Support>

A mixture of a bleached kraft pulp of hardwood (LBKP) and a bleached sulfite pulp of softwood (NBSP) with a ratio of 1:1 was subjected to beating until it becomes 300 ml by the Canadian Standard Freeness to prepare a pulp slurry. To the slurry were added alkyl ketene dimer in an amount of 0.5% based on the amount of the pulp as a sizing agent, polyacrylamide in an amount of 1.0% based on the same as a strengthening additive of paper, cationic starch in an amount of 2.0% based on the same, and a polyamide epichlorohydrin resin in an amount of 0.5% based on the same, and the mixture was diluted with water to prepare a slurry with a concentration of 1%. This slurry was made paper by a tourdrinier paper machine to have a basis weight of 170 g/m², dried and subjected to moisture conditioning to prepare a base paper for a polyolefin resin-coated paper. A polyethylene resin composition comprising 100 parts of a low density polyethylene having a density of 0.918 g/cm³ and 10 parts of anatase type titanium and dispersed uniformly in the resin was melted at 320° C. and the melted resin composition was subjected to extrusion coating on a surface of the above-mentioned base paper with a thickness of 35 μm by 200 m/min and subjected to extrusion coating by using a cooling roller subjected to slightly roughening treatment to make a resin-coated paper front surface. On the other surface of the base paper, a blended resin composition comprising 70 parts of a high density polyethylene resin having a density of 0.962 g/cm³ and 30 parts of a low density polyethylene resin having a density of 0.918 g/cm³ was melted similarly at 320° C. and the melted resin composition was subjected to extrusion coating with a thickness of 30 μm and subjected to extrusion coating by using a cooling roller subjected to roughening treatment to make a resin-coated paper back surface.

Onto the front surface of the above-mentioned poly-olefin resin-coated paper was subjected to a high frequency corona discharge treatment, and then, a primer layer coating solution having the composition mentioned below in water was coated thereon to have the gelatin amount of 50 mg/m² (about 0.05 μm) and dried to prepare a support.

### <Primer Layer Coating Solution>

Composition of primer layer coating solution

| | |
|---|---|
| Lime-treated gelatin | 100 parts |
| 2-Ethylhexyl sulfosuccinate | 2 parts |
| Chromium alum | 10 parts |

### <Recording Sheet 1>

### <Silica Dispersion>

To water were added 4 parts of dimethyldiallyl ammonium chloride homopolymer (Molecular weight: 9,000) and 100 parts of fumed silica (Average primary particle size of 7 nm, Specific surface area: 300 m²/g) to prepare a provisional dispersion, and it was treated by a high pressure homogenizer to prepare Silica dispersion 1 with a concentration of solid components of 20%.

### <Fine Inorganic Particles-Containing Coating Solution 1>

Silica dispersion 1 and other chemicals dissolved in water were mixed to prepare fine inorganic particles-containing coating solution 1 with a concentration of solid components of 13.5% having the composition shown below.

Composition of fine inorganic particles-containing coating
solution 1

| | |
|---|---|
| Silica dispersion (As a silica solid component) | 100 parts |
| Acetoacetyl-modified polyvinyl alcohol | 20 parts |
| (Acetoacetylation degree: 3%, Saponification degree: | |
| 98%, Average polymerization degree: 2350) | |

### <Upper Layer Coating Solution 1>

Upper layer coating solution 1 with a concentration of solid components of 5.0% having the composition shown below in water was prepared.

Composition of upper layer coating solution 1

| | |
|---|---|
| Adipic acid dihydrazide | |
| Nonionic surfactant | Small amount |
| (Polyoxyethylene alkyl ether) | |

Fine inorganic particles-containing coating solution 1 as a lower layer and upper layer coating solution 1 as an upper layer were coated by simultaneous multilayer application on the above-mentioned support by means of a slide bead-system coating device so that the coated amount of the fine silica particles of fine inorganic particles-containing coating solution 1 was 20 g/m² and the coated amount of the adipic acid dihydrazide of upper layer coating solution 1 was 0.4 g/m², and heated at 80° C. for 15 seconds to let the coating solution galate, and then blowing air of 70° C. was blown to dry the layers to obtain recording sheet 1.

### <Recording Sheets 2 to 11>

In the same manner as in the recording sheet 1 except for changing the composition of fine inorganic particles-containing coating solution 1 to the following individual compositions of fine inorganic particles-containing coating solution 2, recording sheets 2 to 11 were obtained. The acids shown in Table 1 were individually added.

### <Fine Inorganic Particles-Containing Coating Solution 2>

Composition of fine inorganic particles-containing coating
solution 2.

| | |
|---|---|
| Silica dispersion 1 (As a silica solid component) | 100 parts |
| Acetoacetyl-modified polyvinyl alcohol | 20 parts |
| (Acetoacetylation degree: 3%, Saponification degree: | |
| 98%, Average polymerization degree: 2350) | |
| Acid shown in Table 1 | Amount shown |
| | in Table 1 |

The amount shown in each table is a substantial amount of the components per 1 m² of the recording sheet.

With regard to the obtained respective recording sheets, the following evaluations were carried out. The results are shown in Table 1. Incidentally, an average secondary particle size of the fine silica particle in the recording sheet was each 70 nm.

### <Glossiness at White Portion>

Glossiness at the white paper portion of the recording sheet before printing was observed with inclined light and evaluated by the following criteria.

◯: It possessed high glossy feeling as that of a glossy color photography.

Δ: There was a little glossy feeling.

×: There was no glossy feeling.

### <Ink-Absorption Ability>

By using a commercially available ink-jet printer (manufactured by Seiko Epson K.K., PM-G800), solid printing with red, blue, green or black color was each carried out, and immediately after the printing, a PPC paper was put on the printed portion with a slight pressurization, and the degree of the amount of the ink transferred to the PPC paper was observed with the naked eye and evaluated by the following criteria.

◯: No transfer was observed.

Δ: Pale transfer was observed at the whole part of the printed portion.

×: Dark transfer was observed at the whole part of the printed portion.

### <Color Reproduction>

By using the above printer, solid printing with cyan, magenta, yellow, red, blue, green or black color was each carried out, and the colors were individually measured by means of a calorimeter and the reproduction color spaces were compared to one another. The color reproduction was evaluated by the following three criteria: a recording sheet having a wide reproduction color space was rated ◯; a recording sheet having a slightly poor reproduction color space was rated “Δ”; and a recording sheet having a very poor reproduction color space was rated “×”.

Discoloration with the passage of time is a phenomenon which occurs during the storage in a relatively mild environment for a long term, but the accelerated test method shown below was used in the evaluation of discoloration.

### <Discoloration of Printed Portion>

The recording sheets printed by means of the above printer were stored under conditions at 40° C. for three months, and then evaluated in respect of a change of color tone of the printed portion and its periphery.

◯: The color did not change.

Δ: Slight discoloration occurred.

×: Marked discoloration occurred.

TABLE 1

| | | | Glossiness | Ink- | | Discoloration | |
|---|---|---|---|---|---|---|---|
| | | Amount | at white | absorption | Color | of printed | |
| | Acid (pKa) | (g/m²) | portion | ability | reproduction | portion | Note |
| Recording sheet 1 | — | — | ◯ | Δ | ◯ | X | Comparative Example |
| Recording sheet 2 | Nitric acid (−1.4) | 0.04 | ◯ | ◯ | ◯ | Δ | Comparative Example |
| Recording sheet 3 | Nitric acid (−1.4) | 0.20 | ◯ | Δ | ◯ | Δ | Comparative Example |
| Recording sheet 4 | Trifluoroacetic acic (−0.3) | 0.10 | Δ | ◯ | Δ | ◯ | Comparative Example |
| Recording sheet 5 | Ethylthioacetic acid (5.1) | 0.30 | ◯ | ◯ | ◯ | Δ | Comparative Example |
| Recording sheet 6 | Phosphoric acid (2.1) | 0.15 | ◯ | ◯ | ◯ | Δ | Comparative Example |
| Recording sheet 7 | Acetic acid (4.8) | 0.30 | ◯ | ◯ | ◯ | ◯ | Present invention |
| Recording sheet 8 | Lactic acid (3.9) | 0.35 | ◯ | ◯ | ◯ | ◯ | Present invention |
| Recording sheet 9 | Benzenesulfonic acid (2.6) | 0.25 | ◯ | ◯ | ◯ | ◯ | Present invention |
| Recording sheet 10 | Malic acid (3.4) | 0.15 | ◯ | ◯ | ◯ | ◯ | Present invention |
| Recording sheet 11 | Citric acid (3.1) | 0.15 | ◯ | ◯ | ◯ | ◯ | Present invention |

From the results shown in Table 1, it is apparent that, by employing the ink-receptive layer having the construction in the present invention, an ink-jet recording material having high glossiness and exhibiting excellent ink-absorption ability and excellent color reproduction can be obtained at high production efficiency, and that, by virtue of containing the organic acid having the pKa defined in the present invention, the recording material is prevented from suffering discoloration of the printed portion with the passage of time.

### EXAMPLE 2

### <Recording Sheets 12 to 21>

In the same manner as in the recording sheet 1 except for changing the composition of upper layer coating solution 1 to the following individual compositions of upper layer coating solution 2, recording sheets 12 to 21 were obtained.

### <Upper Layer Coating Solution 2>

Composition of upper layer coating solution 2

| | |
|---|---|
| Adipic acid dihydrazide | |
| Nonionic surfactant | Small amount |
| (Polyoxyethylene alkyl ether) | |
| Acid shown in Table 2 | Amount shown in Table 2 |

With regard to the obtained respective recording sheets, the same evaluations as in Example 1 were carried out. The results are shown in Table 2.

TABLE 2

| | | | Glossiness | Ink- | | Discoloration | |
|---|---|---|---|---|---|---|---|
| | | Amount | at white | absorption | Color | of printed | |
| | Acid | (g/m²) | portion | ability | reproduction | portion | Note |
| Recording sheet 12 | Nitric acid | 0.04 | ◯ | ◯ | ◯ | Δ | Comparative Example |
| Recording sheet 13 | Nitric acid | 0.20 | ◯ | Δ | ◯ | Δ | Comparative Example |
| Recording sheet 14 | Trifluoroacetic acid | 0.10 | Δ | ◯ | Δ | ◯ | Comparative Example |
| Recording sheet 15 | Ethylthioacetic acid | 0.30 | ◯ | ◯ | ◯ | Δ | Comparative Example |
| Recording sheet 16 | Phosphoric acid | 0.15 | ◯ | ◯ | ◯ | Δ | Comparative Example |
| Recording sheet 17 | Acetic acid | 0.30 | ◯ | ◯ | ◯ | ◯ | Present invention |
| Recording sheet 18 | Lactic acid | 0.35 | ◯ | ◯ | ◯ | ◯ | Present invention |
| Recording sheet 19 | Benzenesulfonic acid | 0.25 | ◯ | ◯ | ◯ | ◯ | Present invention |
| Recording sheet 20 | Malic acid | 0.15 | ◯ | ◯ | ◯ | ◯ | Present invention |
| Recording sheet 21 | Citric acid | 0.15 | ◯ | ◯ | ◯ | ◯ | Present invention |

From the results shown in Table 2, it is also apparent that, by employing the ink-receptive layer having the construction in the present invention, an ink-jet recording material having high glossiness and exhibiting excellent ink-absorption ability and excellent color reproduction can be obtained at high production efficiency, and that, by virtue of containing the organic acid having the pKa defined in the present invention, the recording material is prevented from suffering discoloration of the printed portion with the passage of time.

### EXAMPLE 3

### <Recording Sheets 22 to 41>

### <Alumina Hydrate Dispersion>

To water were added nitric acid (1.5 part) and an alumina hydrate having a pseudoboehmite structure (average primary particle size of 14 nm), and by using a saw blade type dispersing device, an alumina hydrate dispersion with a concentration of solid components of 32% was prepared.

### <Fine Inorganic Particles-Containing Coating Solution 3>

The alumina hydrate dispersion and other chemicals dissolved in water were mixed to prepare fine inorganic particles-containing coating solution 3 with a concentration of solid components of 24% having the composition shown below.

Composition of fine inorganic particles-containing coating
solution 3

| | |
|---|---|
| Alumina hydrate dispersion (As the alumina hydrate solid | 100 parts |
| component) | |
| Acid (1) shown in Table 3 | Amount shown |
| | in Table 3 |
| Acetoacetyl-modified polyvinyl alcohol | 12 parts |
| (Acetoacetylation degree: 3%, Saponification degree: | |
| 98%, Average polymerization degree: 2350) | |
| Mixture of acid (2) and alkali metal salt of an organic | Amount shown |
| acid shown in Table 3 | in Table 3 |

### <Upper Layer Coating Solution 3>

Upper layer coating solution 3 with a concentration of solid components of 3.0% having the composition shown below in water was prepared.

Composition of upper layer coating solution 3

| | |
|---|---|
| Adipic acid dihydrazide | |
| Nonionic surfactant | Small amount |
| (Polyoxyethylene alkyl ether) | |

Fine inorganic particles-containing coating solution 3 as a lower layer and upper layer coating solution 3 as an upper layer were coated by simultaneous multilayer application on the above-mentioned support by means of a slide bead-system coating device so that the coated amount of the alumina hydrate particles of fine inorganic particles-containing coating solution 3 was 35 g/m² and the coated amount of the adipic acid dihydrazide of upper layer coating solution 3 was 0.2 g/m²₁ and heated at 80° C. for 8 seconds to let the coating solution galate, and then blowing air of 70° C. was blown to dry the layers to obtain recording sheets 22 to 41.

With regard to the obtained respective recording sheets, the same evaluations as in Example 1 were carried out except for glossiness at white portion. The evaluation of glossiness at white portion was conducted as follows. The results are shown in Table 3.

### <Glossiness at White Portion>

With respect to the surface of the ink-receptive layer of each recording sheet, 75° specular glossiness was measured in accordance with ISO-8254, and evaluated by the following criteria.

⊚: Or more.

◯: To less than 75.

Δ: 40 To less than 50.

×: Less than 40.

TABLE 3

| | Acid (1) | | Acid (2)/alkali metal salt of organic acid | | Molar |
|---|---|---|---|---|---|
| | | Amount | | Amount | ratio |
| | Type | (g/m²) | Type | (g/m²) | (%) |
| Recording sheet 22 | — | — | — | — | — |
| Recording sheet 23 | Nitric acid | 0.10 | — | — | — |
| Recording sheet 24 | Nitric acid | 0.40 | — | — | — |
| Recording sheet 25 | Trifluoroacetic acid | 0.20 | — | — | — |
| Recording sheet 26 | Ethylthioacetic acid | 0.40 | — | — | — |
| Recording sheet 27 | Acetic acid | 0.35 | — | — | — |
| Recording sheet 28 | Acetic acid | 0.80 | — | — | — |
| Recording sheet 29 | Acetic acid | 0.35 | — | — | — |
| Recording sheet 30 | — | — | Acetic acid/Sodium acetate | 0.35/0.35 | 72 |
| Recording sheet 31 | — | — | Acetic acid/Sodium acetate | 0.70/0.70 | 72 |
| Recording sheet 32 | — | — | Acetic acid/Sodium acetate | 0.35/0.60 | 124 |
| Recording sheet 33 | — | — | Lactic acid/Sodium lactate | 0.35/0.35 | 80 |
| Recording sheet 34 | — | — | Lactic acid/Sodium lactate | 0.70/0.70 | 80 |
| Recording sheet 35 | Acetic acid | 0.35 | Lactic acid/Sodium lactate | 0.70/0.70 | 45 |
| Recording sheet 36 | — | — | Lactic acid/Sodium lactate | 2.00/0.70 | 28 |
| Recording sheet 37 | — | — | Lactic acid/Sodium lactate | 2.00/0.30 | 12 |
| Recording sheet 38 | Acetic acid | 0.35 | Lactic acid/Sodium lactate | 0.35/1.35 | 122 |
| Recording sheet 39 | — | — | Lactic acid/Sodium lactate | 0.35/0.55 | 125 |
| Recording sheet 40 | — | — | Formic acid/Sodium formate | 0.70/0.70 | 67 |
| | | | (Formic acid pKa = 3.8) | | |
| Recording sheet 41 | Acetic acid | 0.35 | Lactic acid/Sodium hydroxide | 1.24/0.30 | 39 |

| | Glossiness | Ink- | | Discoloration | |
|---|---|---|---|---|---|
| | at white | absorption | Color | of printed | |
| | portion | ability | reproduction | portion | Note |
| Recording sheet 22 | ◯ | Δ | ◯ | X | Comparative Example |
| Recording sheet 23 | Δ | Δ | Δ | Δ | Comparative Example |
| Recording sheet 24 | Δ | X | X | Δ | Comparative Example |
| Recording sheet 25 | ◯ | X | Δ | ◯ | Comparative Example |
| Recording sheet 26 | ◯ | Δ | ◯ | Δ | Comparative Example |
| Recording sheet 27 | ◯ | ◯ | ◯ | ◯ | Present invention |
| Recording sheet 28 | ◯ | ◯ | ◯ | ◯ | Present invention |
| Recording sheet 29 | ◯ | ◯ | ◯ | ◯ | Present invention |
| Recording sheet 30 | ⊚ | ◯ | ◯ | ◯ | Present invention |
| Recording sheet 31 | ⊚ | ◯ | ◯ | ◯ | Present invention |
| Recording sheet 32 | ◯ | ◯ | ◯ | ◯ | Present invention |
| Recording sheet 33 | ⊚ | ◯ | ◯ | ◯ | Present invention |
| Recording sheet 34 | ⊚ | ◯ | ◯ | ◯ | Present invention |
| Recording sheet 35 | ⊚ | ◯ | ◯ | ◯ | Present invention |
| Recording sheet 36 | ⊚ | ◯ | ◯ | ◯ | Present invention |
| Recording sheet 37 | ⊚ | ◯ | ◯ | ◯ | Present invention |
| Recording sheet 38 | ◯ | ◯ | ◯ | ◯ | Present invention |
| Recording sheet 39 | ◯ | ◯ | ◯ | ◯ | Present invention |
| Recording sheet 40 | ⊚ | ◯ | ◯ | ◯ | Present invention |
| Recording sheet 41 | ⊚ | ◯ | ◯ | ◯ | Present invention |

From the results shown in Table 3, it is apparent that, by employing the ink-receptive layer having the construction in the present invention, an ink-jet recording material having high glossiness and exhibiting excellent ink-absorption ability and excellent color reproduction can be obtained at high production efficiency, and that, by virtue of containing the organic acid having the pKa defined in the present invention, the recording material is prevented from suffering discoloration of the printed portion with the passage of time. In addition, by further adding an alkali metal salt of an organic acid in an appropriate amount, a sample having higher glossiness could be obtained. In this sample, even when the gelation time after the application was 8 seconds which is about half of the gelation time in Examples 1 and 2, the gelation satisfactorily proceeded, which suggests that the production efficiency is further increased. Recording sheets 27 to 29 to which only the organic acid having the pKa defined in the present invention is added have slightly low glossiness, as compared to the recording sheet to which an alkali metal salt of-an organic acid is further added. The reason for this is presumed that the gelation is slightly unsatisfactory. In recording sheets 23 and 24 to which nitric acid was added, the gelation was inhibited, leading to the lowering of glossiness. In recording sheets 32, 38, and 39 to which an alkali metal salt of an organic acid was added in too large an amount, when a mixture of the organic acid having the pKa defined in the present invention and the alkali metal salt of an organic acid was added to the coating solution, the coating solution suffers slight aggregation, which slightly adversely affected the glossiness of the recording sheet.

### EXAMPLE 4

### <Recording Sheets 42 to 57>

In the same manner as in the recording sheet 22 except for changing the composition of upper layer coating solution 3 to the following individual compositions of upper layer coating solution 4, recording sheets 42 to 57 were obtained.

### <Upper Layer Coating Solution 4>

Composition of upper layer coating solution 4

| | |
|---|---|
| Adipic acid dihydrazide | |
| Nonionic surfactant | Small amount |
| (Polyoxyethylene alkyl ether) | |
| Solution of acid and alkali metal salt | Amount shown in Table 4 |
| of an organic acid shown in Table 4 | |

With regard to the obtained respective recording sheets, the same evaluations as in Example 3 were carried out. The results are shown in Table 4.

TABLE 4

| | | | Glossiness | Ink- | | Discoloration | |
|---|---|---|---|---|---|---|---|
| | Acid/alkali metal salt of | | at white | absorption | Color | of printed | |
| | organic acid | Amount (g/cm²) | portion | ability | reproduction | portion | Note |
| Recording sheet 42 | — | — | ◯ | Δ | ◯ | X | Comparative Example |
| Recording sheet 43 | Nitric acid | 0.04 | Δ | Δ | Δ | Δ | Comparative Example |
| Recording sheet 44 | Nitric acid | 0.20 | Δ | X | X | Δ | Comparative Example |
| Recording sheet 45 | Trifluoroacetic acid | 0.10 | ◯ | X | Δ | ◯ | Comparative Example |
| Recording sheet 46 | Ethylthioacetic acid | 0.30 | ◯ | Δ | ◯ | Δ | Comparative Example |
| Recording sheet 47 | Acetic acid | 0.35 | ◯ | ◯ | ◯ | ◯ | Present invention |
| Recording sheet 48 | Acetic acid | 0.80 | ◯ | ◯ | ◯ | ◯ | Present invention |
| Recording sheet 49 | Lactic acid | 0.35 | ◯ | ◯ | ◯ | ◯ | Present invention |
| Recording sheet 50 | Acetic acid/Sodium acetate | 0.35/0.35 | ⊚ | ◯ | ◯ | ◯ | Present invention |
| Recording sheet 51 | Acetic acid/Sodium acetate | 0.70/0.70 | ⊚ | ◯ | ◯ | ◯ | Present invention |
| Recording sheet 52 | Lactic acid/Sodium lactate | 0.35/0.35 | ⊚ | ◯ | ◯ | ◯ | Present invention |
| Recording sheet 53 | Lactic acid/Sodium lactate | 0.70/0.70 | ⊚ | ◯ | ◯ | ◯ | Present invention |
| Recording sheet 54 | Lactic acid/Sodium lactate | 2.00/0.70 | ⊚ | ◯ | ◯ | ◯ | Present invention |
| Recording sheet 55 | Lactic acid/Sodium lactate | 2.00/0.30 | ⊚ | ◯ | ◯ | ◯ | Present invention |
| Recording sheet 56 | Formic acid/Sodium formate | 0.70/0.70 | ⊚ | ◯ | ◯ | ◯ | Present invention |
| Recording sheet 57 | Lactic acid/Sodium hydroxide | 1.24/0.30 | ⊚ | ◯ | ◯ | ◯ | Present invention |

From the results shown in Table 4, it is apparent that, even when a mixture of the organic acid having the pKa defined in the present invention and the alkali metal salt of an organic acid is added to the upper layer coating solution, results similar to those in Example 3 are obtained.

### EXAMPLE 5

### <Recording Sheets 58 to 74>

Lower layer coating solution 1 shown below was preliminarily coated on a support by means of a rod bar so that the coated amount of-the adipic acid dihydrazide was 0.2 g/m² and dried and then, fine inorganic particles-containing coating solution 4 shown below was coated on the resultant support by means of a slide bead-system coating device so that the coated amount of the alumina hydrate particles was 35 g/m², and heated at 80° C. for 8 seconds to let the coating solution galate, and then blowing air of 70° C. was blown to dry the layer to obtain recording sheets 58 to 74.

### <Lower Layer Coating Solution 1>

Lower layer coating solution 1 with a concentration of solid components of 4.0% having the composition shown below in water was prepared.

Composition of lower layer coating solution 1

| | |
|---|---|
| Adipic acid dihydrazide | 100 parts |
| Partially-saponified polyvinyl alcohol | 100 parts |
| (Saponification degree: 88%, | |
| Average polymerization degree: 500) | |

### <Fine Inorganic Particles-Containing Coating Solution 4>

The alumina hydrate dispersion and other chemicals dissolved in water were mixed to prepare fine inorganic particles-containing coating solution 4 with a concentration of solid components of 24% having the composition shown below.

Composition of fine inorganic particles-containing coating
solution 4

| | |
|---|---|
| Alumina hydrate dispersion (As the alumina hydrate | 100 parts |
| solid component) | |
| Acid (1) shown in Table 5 | Amount shown |
| | in Table 5 |
| Acetoacetyl-modified polyvinyl alcohol | 12 parts |
| (Acetoacetylation degree: 3%, Saponification degree: | |
| 98%, Average polymerization degree: 2350) | |
| Mixture of acid and alkali metal salt of an organic acid | Amount shown in |
| shown in Table 5 | Table 5 |
| Nonionic surfactant | Small amount |
| (Polyoxyethylene alkyl ether) | |

With regard to the obtained respective recording sheets, the same evaluations as in Example 3 were carried out. The results are shown in Table 5.

TABLE 5

| | | | | | Glossiness | Ink- | Color | Discoloration | |
|---|---|---|---|---|---|---|---|---|---|
| | | Amount | Acid (2)/alkali metal | Amount | at white | absorption | repro- | of printed | |
| | Acid (1) | (g/m²) | salt of organic acid | (g/m²) | portion | ability | duction | portion | Note |
| Recording sheet 58 | — | — | — | — | ◯ | Δ | ◯ | X | Comparative |
| | | | | | | | | | Example |
| Recording sheet 59 | Nitric acid | 0.10 | — | — | Δ | Δ | Δ | Δ | Comparative |
| | | | | | | | | | Example |
| Recording sheet 60 | Nitric acid | 0.40 | — | — | Δ | X | X | Δ | Comparative |
| | | | | | | | | | Example |
| Recording sheet 61 | Trifluoroacetic | 0.20 | — | — | ◯ | X | Δ | ◯ | Comparative |
| | acid | | | | | | | | Example |
| Recording sheet 62 | Ethylthioacetic | 0.40 | — | — | ◯ | Δ | ◯ | Δ | Comparative |
| | acid | | | | | | | | Example |
| Recording sheet 63 | Acetic acid | 0.35 | — | — | ◯ | ◯ | ◯ | ◯ | Present invention |
| Recording sheet 64 | Acetic acid | 0.80 | — | — | ◯ | ◯ | ◯ | ◯ | Present invention |
| Recording sheet 65 | Lactic acid | 0.35 | — | — | ◯ | ◯ | ◯ | ◯ | Present invention |
| Recording sheet 66 | — | — | Acetic acid/Sodium | 0.35/0.35 | ⊚ | ◯ | ◯ | ◯ | Present invention |
| | | | acetate | | | | | | |
| Recording sheet 67 | — | — | Acetic acid/Sodium | 0.70/0.70 | ⊚ | ◯ | ◯ | ◯ | Present invention |
| | | | acetate | | | | | | |
| Recording sheet 68 | — | — | Lactic acid/Sodium | 0.35/0.35 | ⊚ | ◯ | ◯ | ◯ | Present invention |
| | | | lactate | | | | | | |
| Recording sheet 69 | — | — | Lactic acid/Sodium | 0.70/0.70 | ⊚ | ◯ | ◯ | ◯ | Present invention |
| | | | lactate | | | | | | |
| Recording sheet 70 | Acetic acid | 0.35 | Lactic acid/Sodium | 0.70/0.70 | ⊚ | ◯ | ◯ | ◯ | Present invention |
| | | | lactate | | | | | | |
| Recording sheet 71 | — | 0.35 | Lactic acid/Sodium | 2.00/0.70 | ⊚ | ◯ | ◯ | ◯ | Present invention |
| | | | lactate | | | | | | |
| Recording sheet 72 | — | 0.35 | Lactic acid/Sodium | 2.00/0.30 | ⊚ | ◯ | ◯ | ◯ | Present invention |
| | | | lactate | | | | | | |
| Recording sheet 73 | — | 0.35 | Formic acid/Sodium | 0.70/0.70 | ⊚ | ◯ | ◯ | ◯ | Present invention |
| | | | formate | | | | | | |
| Recording sheet 74 | Acetic acid | 0.35 | Lactic acid/Sodium | 1.24/0.30 | ⊚ | ◯ | ◯ | ◯ | Present invention |
| | | | hydroxide | | | | | | |

As can be seen from Table 5, even when the coating method is changed from the simultaneous multilayer application to the successive application, results similar to those in Example 3 are obtained.

### EXAMPLE 6

### <Recording Sheets 75 to 88>

In the same manner as in the recording sheet 22 except for changing the support to a support to which the following lower layer coating solution 2 was applied by means of a rod bar so that the coated amount of the partially-saponified polyvinyl alcohol was 0.2 g/m² and dried, recording sheets 75 to 88 were prepared.

### <Lower Layer Coating Solution 2>

Lower layer coating solution 2 with a partially-saponified polyvinyl alcohol concentration of solid components of 2.0% having the composition shown below in water was prepared.

Composition of lower layer coating solution 2

| | |
|---|---|
| Mixture of acid and alkali metal salt of an | Amount shown in |
| organic acid shown in Table 6 | Table 6 |
| Partially-saponified polyvinyl alcohol | |
| (Saponification degree: 88%, | |
| Average polymerization degree: 500) | |

With regard to the obtained respective recording sheets, the same evaluations as in Example 3 were carried out. The results are shown in Table 6.

TABLE 6

| | | | Glossiness | Ink- | | Discoloration | |
|---|---|---|---|---|---|---|---|
| | Acid/alkali metal salt of | | at white | absorption | Color | of printed | |
| | organic acid | Amount (g/m²) | portion | ability | reproduction | portion | Note |
| Recording sheet 75 | — | — | ◯ | Δ | ◯ | X | Comparative Example |
| Recording sheet 76 | Nitric acid | 0.04 | Δ | Δ | Δ | Δ | Comparative Example |
| Recording sheet 77 | Nitric acid | 0.20 | Δ | X | X | Δ | Comparative Example |
| Recording sheet 78 | Trifluoroacetic acid | 0.10 | ◯ | X | Δ | ◯ | Comparative Example |
| Recording sheet 79 | Ethylthioacetic acid | 0.30 | ◯ | Δ | ◯ | Δ | Comparative Example |
| Recording sheet 80 | Acetic acid | 0.35 | ◯ | ◯ | ◯ | ◯ | Present invention |
| Recording sheet 81 | Lactic acid | 0.35 | ◯ | ◯ | ◯ | ◯ | Present invention |
| Recording sheet 82 | Acetic acid/Sodium acetate | 0.70/0.70 | ⊚ | ◯ | ◯ | ◯ | Present invention |
| Recording sheet 83 | Acetic acid/Sodium acetate | 0.35/0.60 | ◯ | ◯ | ◯ | ◯ | Present invention |
| Recording sheet 84 | Lactic acid/Sodium lactate | 0.70/0.70 | ⊚ | ◯ | ◯ | ◯ | Present invention |
| Recording sheet 85 | Lactic acid/Sodium lactate | 2.00/0.70 | ⊚ | ◯ | ◯ | ◯ | Present invention |
| Recording sheet 86 | Lactic acid/Sodium lactate | 2.00/0.30 | ⊚ | ◯ | ◯ | ◯ | Present invention |
| Recording sheet 87 | Lactic acid/Sodium lactate | 0.35/0.55 | ◯ | ◯ | ◯ | ◯ | Present invention |
| Recording sheet 88 | Lactic acid/Sodium hydroxide | 1.24/0.30 | ⊚ | ◯ | ◯ | ◯ | Present invention |

As can be seen from Table 6, even when using the support to which a mixture of the organic acid having the pKa defined in the present invention and the alkali metal salt of an organic acid was preliminarily applied and dried, results similar to those in Example 3 are obtained. When the alkali metal salt of an organic acid was added in too large an amount, the glossiness was slightly lowered.

1. An ink-jet recording material comprising, on a support, at least one ink-receptive layer containing fine inorganic particles having an average secondary particle size of 500 nm or less, a resin binder having an acetoacetyl group, and compound having two or more terminal hydrazine groups,
wherein the at least one ink-receptive layer contains at least one organic acid having a pKa of 2 to 5.

2. The ink-jet recording material according to claim 1, wherein an amount of the organic acid having a pKa of 2 to 5 is 0.01 to 1 g per 1 m² of the ink-jet recording material.

3. The ink-jet recording material according to claim 1, wherein the fine inorganic particles comprise amorphous synthetic silica.

4. The ink-jet recording material according to claim 1, wherein the ink-receptive layer containing the organic acid having a pKa of 2 to 5 further contains at least one alkali metal salt of an organic acid in an amount such that an alkali metal ion amount is 10 to 120 mol %, based on per mol of the organic acid having a pKa of 2 to 5.

5. The ink-jet recording material according to claim 4, wherein an amount of the organic acid having a pKa of 2 to 5 is 0.01 to 3.0 g per 1 m² of the ink-jet recording material.

6. The ink-jet recording material according to claim 4, wherein the fine inorganic particles comprise alumina or alumina hydrate.

7. The ink-jet recording material according to claim 1, wherein the organic acid is at least one selected from the group consisting of formic acid, acetic acid, citric acid, lactic acid, malonic acid, succinic acid, malic acid, tartaric acid, fumaric acid, benzoic acid, ascorbic acid, benzenesulfonic acid, and 2,4-dinitrophenol.

8. The ink-jet recording material according to claim 4, wherein the alkali metal salt of an organic acid is at least one selected from the group consisting of sodium formate, potassium formate, sodium acetate, potassium acetate, sodium lactate, potassium lactate, sodium benzoate, potassium benzoate, sodium ascorbate, sodium benzenesulfonate, and potassium benzenesulfonate.
